(19) United States
(12) Patent Application Publication
(10) Pub. No.: US 2026/0177769 A1
(43) Pub. Date: Jun. 25, 2026

(54) COMPONENT COUPLING DEVICE

(71) Applicant: ALL RING TECH CO., LTD., Kaohsiung City (TW)

(72) Inventors: Chun-Hung TSAI, Kaohsiung City (TW); Heng-Hui LIU, Kaohsiung City (TW); Yu-Sheng GUO, Kaohsiung City (TW); Li-Hsin CHEN, Kaohsiung City (TW)

(21) Appl. No.: 19/346,775

(22) Filed: Oct. 1, 2025

(30) Foreign Application Priority Data
Dec. 20, 2024 (TW) 113150071

(51) Int. Cl. G02B 6/42; G02B 6/36

(52) U.S. Cl. CPC G02B 6/4295; G02B 6/3604; G02B 6/366; G02B 6/4221; G02B 6/4244

(57) ABSTRACT

A component coupling device is adapted to couple a fiber array unit to an integrated circuit component, and includes a first drive mechanism, a second drive mechanism, and a retention mechanism. The second drive mechanism is disposed on the first drive mechanism and is driven by the first drive mechanism to move linearly in a plurality of directions. The retention mechanism is disposed on the second drive mechanism and is driven by the second drive mechanism to rotate about a plurality of axes.

### CROSS-REFERENCE TO RELATED APPLICATION

This application claims priority to Taiwanese Invention Patent Application No. 113150071, filed on December 20, 2024, the entire disclosure of which is incorporated by reference herein.

### FIELD

The disclosure relates to a component coupling device, and more particularly to a component coupling device for coupling a fiber array unit to an integrated circuit component.

### BACKGROUND

In a semiconductor manufacturing process, in order to produce chips that have relatively high transmission performance and relatively low power consumption, silicon photonics (SiPh) technology has become the focus of industry development. In silicon photonics technology, such as a pluggable transceiver optics (PTO) infrastructure, an on-board optics (OBO) infrastructure, a co-packaged optics (CPO) infrastructure and an optical input/output (optical I/O) infrastructure, it is necessary to couple a fiber array unit (FAU) to an integrated circuit component. The process of integrated circuit component packaging has progressed to two-point-five dimensional (2.5D) IC packaging and three-dimensional (3D) IC packaging, and integrated circuit components and fiber optic array units also have to be modified in structure accordingly. For example, the integrated circuit component includes photonic integrated circuits (PIC), and the fiber array unit includes optical couplers, receptacle portions and optical fibers that are connected between the optical couplers and the receptacle portions. The photonic integrated circuits of the integrated circuit component are coupled to the optical couplers of the fiber array unit and may be in optical communication with the external environment through the optical fibers of the fiber array unit.

When the fiber array unit is coupling to the integrated circuit component, the fiber array unit is usually retained by a gantry mechanism that is movable in a first direction, a second direction and a third direction that respectively extend along axis lines X, Y and Z in a Cartesian coordinate system, and the integrated circuit component is usually carried on a carrier mechanism that is rotatable about a first axis and a second axis normal to the first axis. Then the gantry mechanism and the carrier mechanism respectively move the fiber array unit and the integrated circuit component to a predetermined position where the fiber array unit and the integrated circuit component are to be coupled. Although the gantry mechanism and the carrier mechanism are operated independently of each other, since it is necessary for the gantry mechanism to adjust the position of the fiber array unit in conjunction with movement of the carrier mechanism and vice versa, the gantry mechanism and the carrier mechanism may still affect each other. In practice, since it is not easy to control the movement between the gantry mechanism and the carrier mechanism, it is relatively difficult to precisely move the fiber array unit and the integrated circuit component to the predetermined position.

### SUMMARY

Therefore, an object of the present disclosure is to provide a component coupling device that can alleviate at least one of the drawbacks of the prior art.

According to an aspect of the disclosure, a component coupling device adapted to couple a fiber array unit to an integrated circuit component, and includes a first drive mechanism, a second drive mechanism, and a retention mechanism. The second drive mechanism is disposed on the first drive mechanism and is driven by the first drive mechanism to move linearly in a plurality of directions. The retention mechanism is disposed on the second drive mechanism and is driven by the second drive mechanism to rotate about a plurality of axes.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of an integrated circuit component and a fiber array unit to be coupled to the integrated circuit component by an embodiment of a component coupling device according to the present disclosure.

FIG. 2 is a fragmentary schematic section view illustrating the fiber array unit coupled to the integrated circuit component.

FIG. 3 is a perspective view of the fiber array unit.

FIG. 4 is a perspective view of the fiber array unit seen from an angle different from FIG. 3.

FIG. 5 is a fragmentary, partly sectional view illustrating an optical signal transmitted between the fiber array unit and the integrated circuit component.

FIG. 6 is a perspective view illustrating the component coupling disposed on a machine bed.

FIG. 7 is a partly exploded perspective view illustrating a third straight movement unit of the first drive mechanism, a second drive mechanism, a retention mechanism, and an inspection mechanism of the embodiment of the component coupling device.

FIG. 8 is a partly exploded perspective view illustrating a first rotatable assembly, a second rotatable assembly, and a third rotatable assembly of the second drive mechanism.

FIG. 9 is a perspective view illustrating a first movable seat of the first rotatable assembly rotatable about a first axis along a first arcuate path relative to a first base seat of the first rotatable assembly.

FIG. 10 is a perspective view illustrating a second movable seat of the second rotatable assembly rotatable about a second axis along a second arcuate path relative to a second base seat of the second rotatable assembly.

FIG. 11 is a perspective view illustrating a third movable seat of the third rotatable assembly rotatable about a third axis along a third arcuate path relative to a third base seat of the third rotatable assembly.

FIG. 12 is a fragmentary side view illustrating a plurality of connection surfaces of the second drive mechanism.

FIG. 13 is a fragmentary perspective view illustrating the first axis, the second axis, and the third axis intersecting at an axial point.

FIG. 14 is a partly exploded perspective view of the retention mechanism and a curing unit of the retention mechanism.

FIG. 15 is a fragmentary side view illustrating the retention mechanism and an air passage of the retention mechanism.

FIG. 16 is a fragmentary side view illustrating a retention member of the retention mechanism.

FIG. 17 is a fragmentary perspective view illustrating the retention member that is disposed upside down.

FIG. 18 is a perspective view of a drive unit of the retention mechanism.

FIG. 19 is a perspective view of a connector member of the retention mechanism.

FIG. 20 is a fragmentary schematic side view illustrating the connector member being movable relative to the retention member and adapted to be detachably connected to the fiber array unit.

FIG. 21 is a fragmentary schematic perspective view illustrating two first light sources of the curing unit emitting an ultraviolet light toward the fiber array unit.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

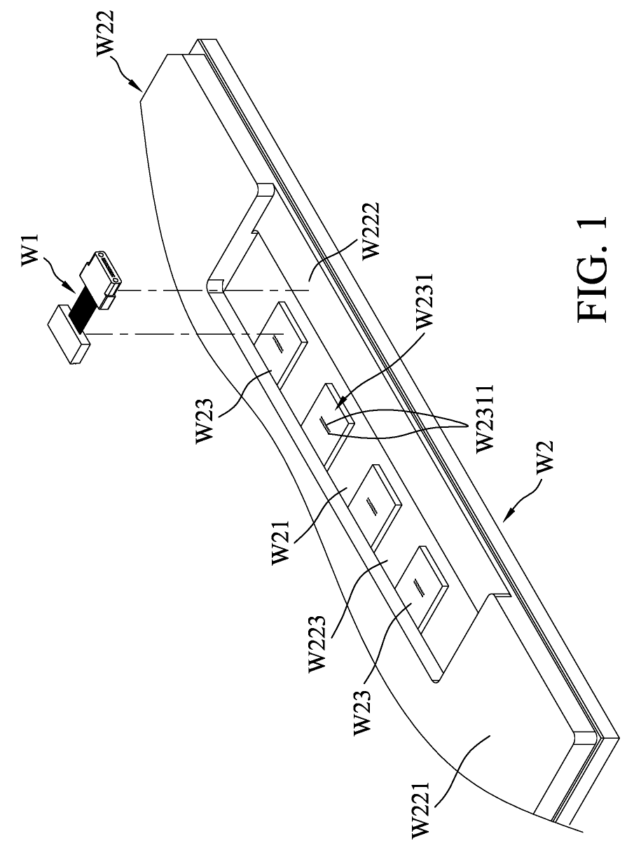

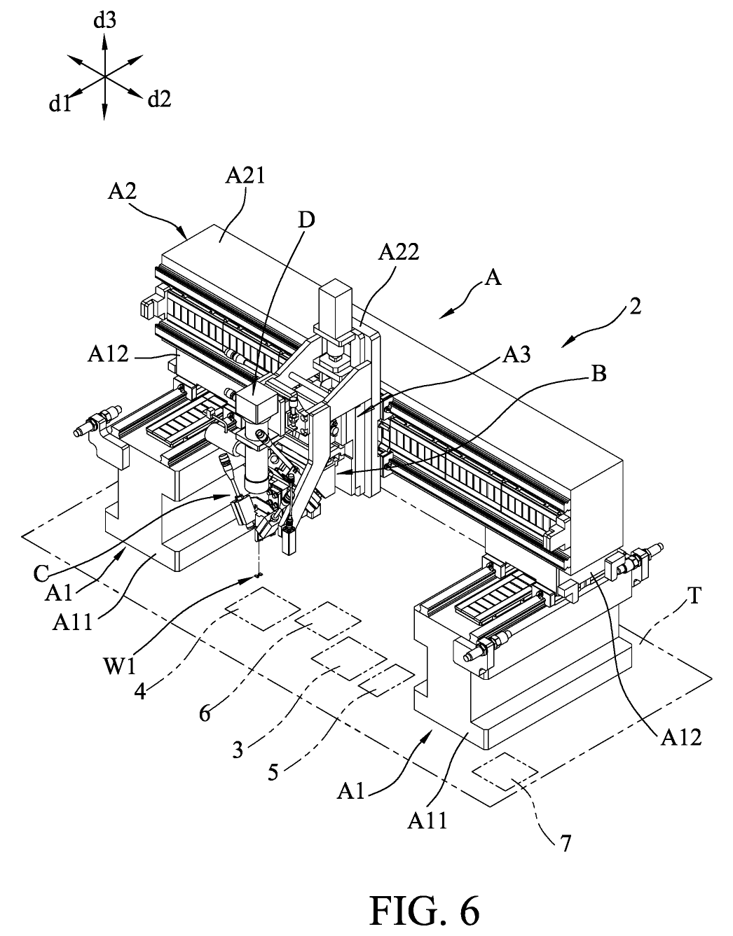

Referring to FIGS. 1 and 6, an embodiment of a component coupling device 2 according to the present disclosure is adapted to be disposed on a machine bed (T), adapted to retain and move a fiber array unit (W1), and adapted to couple the fiber array unit (W1) to an integrated circuit component (W2).

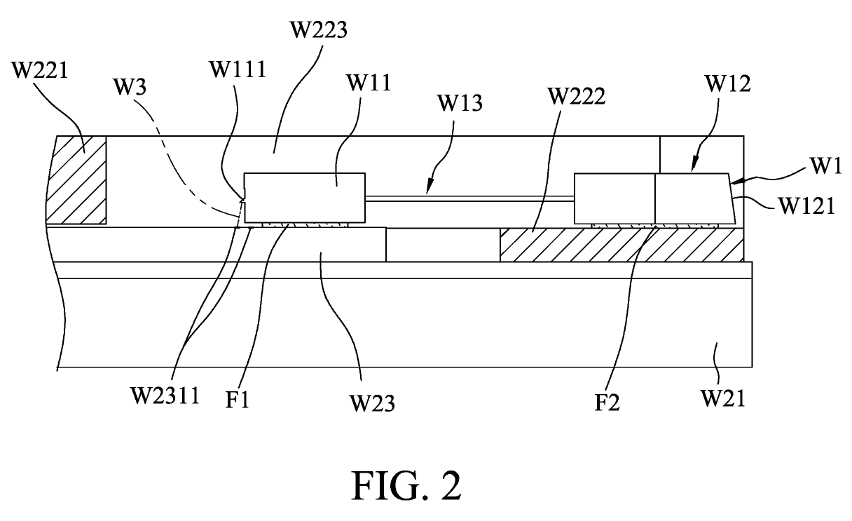

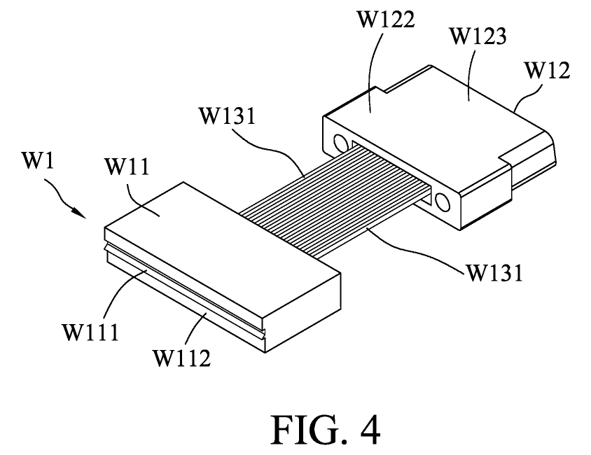

Further referring to FIGS. 2 to 4, the fiber array unit (W1) includes an optical coupler (W11), a receptacle portion (W12), and an optical fiber portion (W13) connected to the optical coupler (W11) and the receptacle portion (W12). The optical coupler (W11) and the receptacle portion (W12) are spaced apart from each other. The optical coupler (W11) is made of a light-transmissive material, and includes a prism (W111) that is formed on a first side surface (W112) of the optical coupler (W11) which is distal from the receptacle portion (W12). The receptacle portion (W12) is provided for the optical fiber portion (W13) to extend therethrough such that the optical fiber portion (W13) is exposed outwardly from a second side surface (W121) of the receptacle portion (W12) that is distal from the optical coupler (W11). The receptacle portion (W12) includes a first seat portion (W122), a second seat portion (W123) having a width smaller than a width of the first seat portion (W122) in a direction transverse to a direction that the optical fiber portion (W13) extends in, and two guide holes (W124) extending through the first seat portion (W122) and the second seat portion (W123). As shown in FIG. 2, the second side surface (W121) of the receptacle portion (W12) is tilted outwardly from top to bottom. The optical fiber portion (W13) includes a plurality of optical fibers (W131) and is flexible.

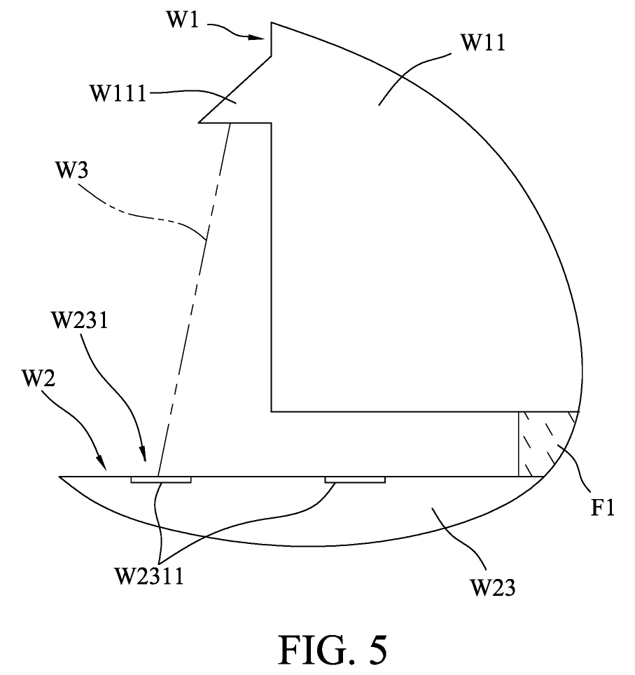

Referring back to FIGS. 1 and 2, the integrated circuit component (W2) includes a carrier board (W21), a lid unit (W22), and at least one photonic integrated circuit (W23) disposed on the carrier board (W21). In this embodiment, a plurality of photonic integrated circuits (W23) are disposed on the carrier board (W21) and are arranged on one side of the carrier board (W21). The lid unit (W22) includes a first lid portion (W221), a second lid portion (W222) that is lower in height than the first lid portion (W221), and a recess portion (W223) that is disposed between the first lid portion (W221) and the second lid portion (W222) and that exposes the photonic integrated circuits (W23) therefrom. The recess portion (W223) is formed according to a design of positions of the photonic integrated circuits (W23) and is not limited to the above example. For example, in some embodiments, the recess portions (W223) are disposed adjacent to four sides of the carrier board (W21) that is rectangular. Each of the photonic integrated circuits (W23) includes a lens array (W231). As shown in FIGS. 2 and 5, the lens array (W231) includes a plurality of lenses (W2311) that are arranged as a matrix. It should be noted that since the structures of the photonic integrated circuits (W23) are the same, only one of the photonic integrated circuits (W23) will be described in the following description for the sake of brevity.

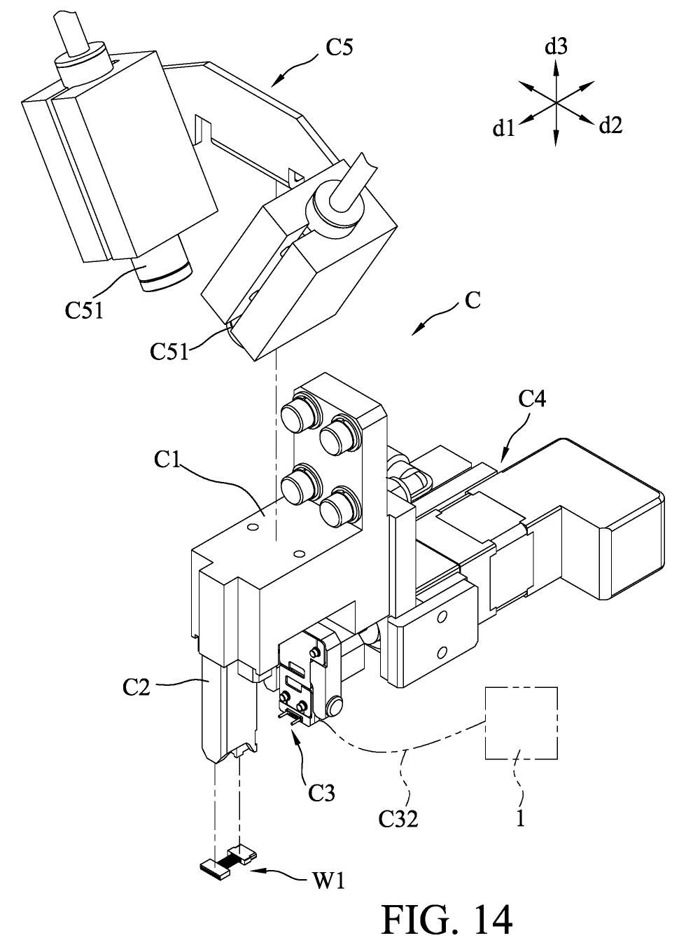

Referring to FIGS. 2 and 5, when the fiber array unit (W1) is coupled to the photonic integrated circuit (W23) of the integrated circuit component (W2), the optical coupler (W11) of the fiber array unit (W1) is in contact with and abuts against the photonic integrated circuit (W23) and the receptacle portion (W12) is in contact with the second lid portion (W222) of the lid unit (W22). The prism (W111) of the optical coupler (W11) of the fiber array unit (W1) is disposed to correspond in position to the lens array (W231) of the photonic integrated circuit (W23) such that an optical signal (W3) may be transmitted between the prism (W111) of the fiber array unit (W1) and the lens array (W231) of the photonic integrated circuit (W23). The optical signal (W3) is outputted from a measurement unit 1 (see FIG. 14), is transmitted to the fiber array unit (W1), is transmitted into the photonic integrated circuit (W23) from the fiber array unit (W1), and is transmitted back to the fiber array unit (W1) from the photonic integrated circuit (W23), sequentially. The measurement unit 1 is for measuring an intensity of the optical signal (W3) transmitted back to the fiber array unit (W1). Specifically, the optical signal (W3) is refracted by the prism (W111) and propagates inclinedly, forwardly and downwardly as depicted in FIG. 5 to enter the lenses (W2311) of the lens array (W231). The optical coupler (W11) and the photonic integrated circuit (W23) may be connected to each other by a first adhesive (F1), and the receptacle portion (W12) and the second lid portion (W222) may be connected to each other by a second adhesive (F2). Each of the first adhesive (F1) and the second adhesive (F2) is an ultraviolet cured adhesive or a heat cured adhesive. It should be noted that, in other embodiments of the present disclosure, the second lid portion (W222) may be omitted and the lid unit (W22) may only include the first lid portion (W221), so that the receptacle portion (W12) is in contact with and abuts against the carrier board (W21).

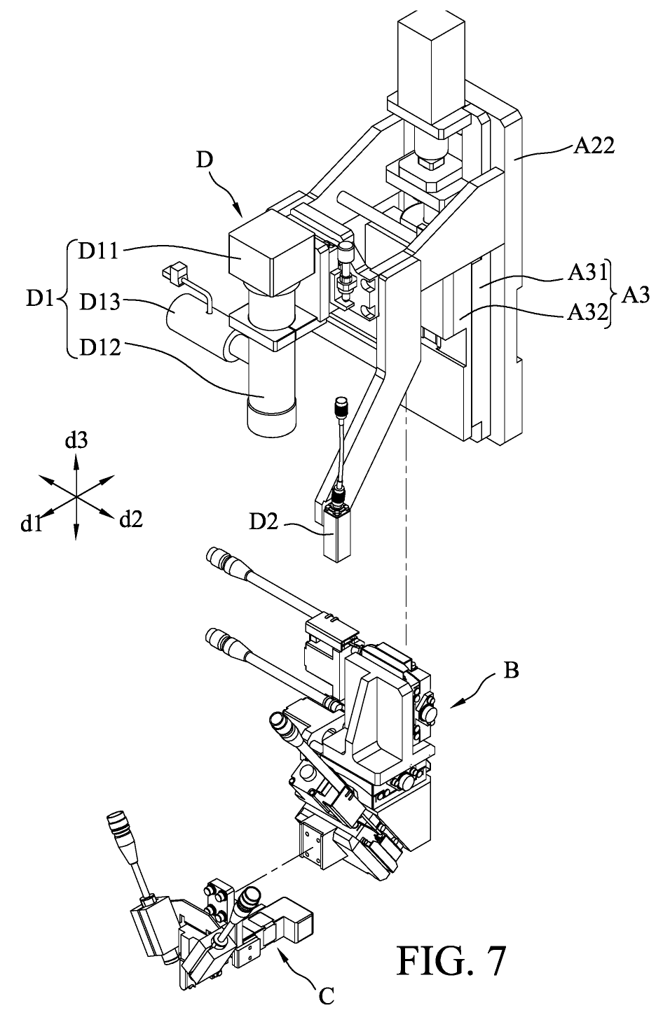

Referring to FIGS. 6 and 7, in the following description, a first direction (d1) is a horizontal direction, a second direction (d2) is another horizontal direction normal to the first direction (d1), and a third direction (d3) is a vertical direction normal to the first direction (d1) and the second direction (d2). In this embodiment, the first direction (d1) is a front-rear direction, the second direction (d2) is a left-right direction, and the third direction (d3) is an up-down direction. A first stage 3, a second stage 4 spaced apart from the first stage 3 in the second direction (d2), an adhesive coating device 5 disposed at one side of the first stage 3 that is opposite to the second stage 4, a detection device 6 disposed between the first stage 3 and the second stage 4, and a control unit 7 electrically connected to the component coupling device 2, the adhesive coating device 5 and the detection device 6 are disposed on the machined bed (T). The component coupling device 2 includes a first drive mechanism (A), a second drive mechanism (B), a retention mechanism (C), and an inspection mechanism (D). The first drive mechanism (A) is disposed on the machine bed (T). The second drive mechanism (B) is disposed on the first drive mechanism (A) and is driven by the first drive mechanism (A) to move linearly in a plurality of directions. The retention mechanism (C) is disposed on the second drive mechanism (B) and is driven by the second drive mechanism (B) to rotate about a plurality of axes. The retention mechanism (C) is for retaining the fiber array unit (W1) and is driven to move linearly and rotate respectively by the first drive mechanism (A) and the second drive mechanism (B). The inspection mechanism (D) is disposed on the first drive mechanism (A), is driven by the first drive mechanism (A) to move linearly in the plurality of directions, and is adapted for inspection of the integrated circuit component (W2) (see FIG. 1). In this embodiment, the plurality of directions are the first direction (d1), the second direction (d2) and the third direction (d3).

Referring to FIGS. 6 and 7, the first drive mechanism (A) includes a first straight movement unit (A1) adapted to be disposed on the machine bed (T), a second straight movement unit (A2) mounted to the first straight movement unit (A1), and a third straight movement unit (A3) mounted to the second straight movement unit (A2). The first straight movement unit (A1) is operable to drive the second drive mechanism (B) to move linearly in the first direction (d1), and includes two first rail seats (A11) disposed on the machine bed (T) and spaced apart from each other in the second direction (d2), and two first slide seats (A12) disposed respectively on the first rail seats (A11). The first rail seats (A11) extend in the first direction (d1), and each of the first slide seats (A12) is movable along the respective one of the first rail seats (A11) in the first direction (d1). The second straight movement unit (A2) is operable to drive the second drive mechanism (B) to move linearly in the second direction (d2), and includes a second rail seat (A21) disposed across the first slide seats (A12), and a second slide seat (A22) mounted to the second rail seat (A21). The second rail seat (A21) extends in the second direction (d2), and the second slide seat (A22) is movable along the second rail seat (A21) in the second direction (d2). The third straight movement unit (A3) is operable to drive the second drive mechanism (B) to move linearly in the third direction (d3), and includes a third rail seat (A31) mounted to the second slide seat (A22) and a third slide seat (A32) mounted to the third rail seat (A31). The third rail seat (A31) extends in the third direction (d3), and the third slide seat (A32) is movable along the third rail seat (A31) in the third direction (d3). One or more of the first straight movement unit (A1), the second straight movement unit (A2), and the third straight movement unit (A3) drives the second drive mechanism (B) to move linearly such that the retention mechanism (C) drives linear movements of the fiber array unit (W1) in one or more of the first direction (d1), the second direction (d2), and the third direction (d3). In this embodiment, the first straight movement unit (A1) and the second straight movement unit (A2) employ linear motors to drive movements of the first slide seat (A12) and the second slide seat (A22), but the present disclosure is not limited thereto. In other embodiments, a combination of a screw rod and a rotary motor may be utilized to drive movement of the first slide seat (A12) and the second slide seat (A22). It should be noted that in this embodiment, the third straight movement unit (A3) drives movement of the third slide seat (A32) through a combination of a rotary motor and a screw rod, but the present disclosure is not limited thereto. For example, the third straight movement unit (A3) may drive movement of the third slide seat (A32) through a linear motor in other embodiments of the present disclosure.

Referring to FIG. 7, the inspection mechanism (D) is mounted to the second slide seat (A22) of the second straight movement unit (A2), and includes a first image capturing unit (D1) and a distance sensor (D2). The first image capturing unit (D1) includes an imager (D11), a lens (D12), and a light source (D13). Referring back to FIG. 1, the first image capturing unit (D1) is disposed above one of the photonic integrated circuits (W23) and the lens array (W231) of the one of the photonic integrated circuits (W23) of the integrated circuit component (W2) for capturing an image of the one of the photonic integrated circuits (W23) and/or the lens array (W231) to obtain an orientation of the one of the photonic integrated circuits (W23) and/or the lens array (W231). The first image capturing unit (D1) may be, e.g., a charge coupled device (CCD) camera and the imager (D11) may be, e.g., an image processor. The distance sensor (D2) may be, e.g., an optical reflective sensor that is for sensing a distance between the distance sensor (D2) and each of a plurality of points on an upper surface of the photonic integrated circuit (W23) to obtain an inclination degree of the upper surface of the photonic integrated circuit (W23) relative to a horizontal plane normal to the third direction (d3).

Referring to FIGS. 7 to 9, the second drive mechanism (B) includes a first rotatable assembly (B1) mounted to the third slide seat (A32) of the third straight movement unit (A3), a second rotatable assembly (B2) mounted to the first rotatable assembly (B1), and a third rotatable assembly (B3) mounted to the second rotatable assembly (B2).

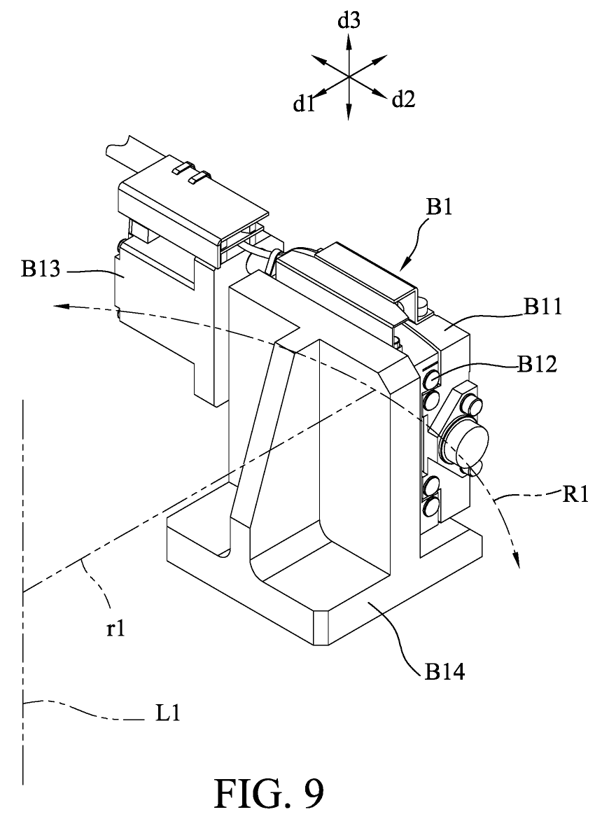

The first rotatable assembly (B1) is operable to drive the retention mechanism (C) (see FIG. 7) to rotate about a first axis (L1), and includes a first base seat (B11) mounted to the third slide seat (A32) (see FIG. 7), a first movable seat (B12) mounted to the first base seat (B11), a first driver (B13) for driving the first movable seat (B12) to move, and a first connecting member (B14) mounted to the first movable seat (B12). The first base seat (B11) is formed with an arcuate concave surface that faces the first movable seat (B12). The first movable seat (B12) is formed with an arcuate convex surface that faces the first base seat (B11) and that is complementary in shape with the arcuate concave surface of the first base seat (B11). The first movable seat (B12) is driven by the first driver (B13) to move arcuately along the first base seat (B11) so that the first connecting member (B14) is driven thereby to move along a first arcuate path (R1) left and right as depicted in FIG. 9. The first movable seat (B12) rotates about the first axis (L1) that is parallel to the third direction (d3). As shown in FIG. 9, a distance between each of a plurality of points on the first arcuate path (R1) and the first axis (L1) is defined as a first radius (r1). In this embodiment, the first base seat (B11) and the first movable seat (B12) are movable relative to each other through a cross bearing, but the present disclosure is not limited hereto.

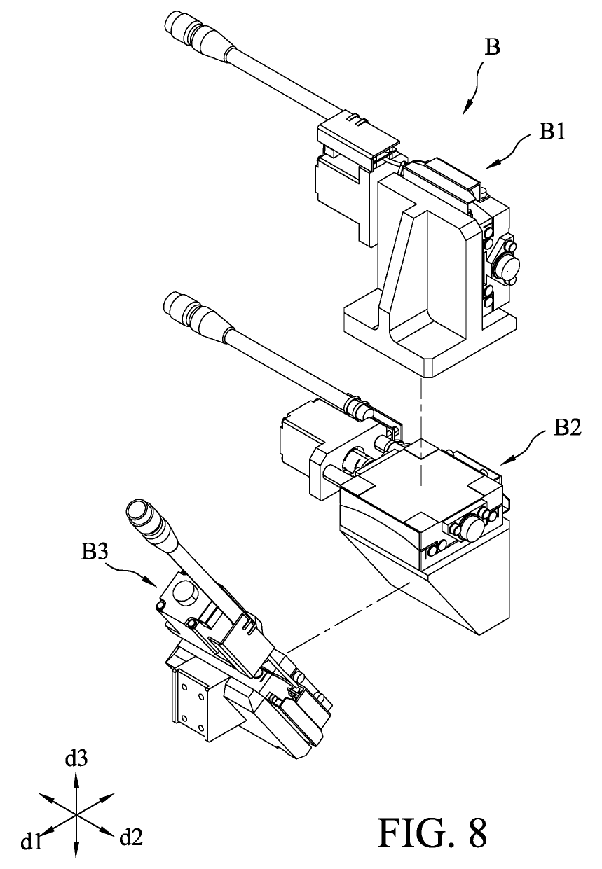

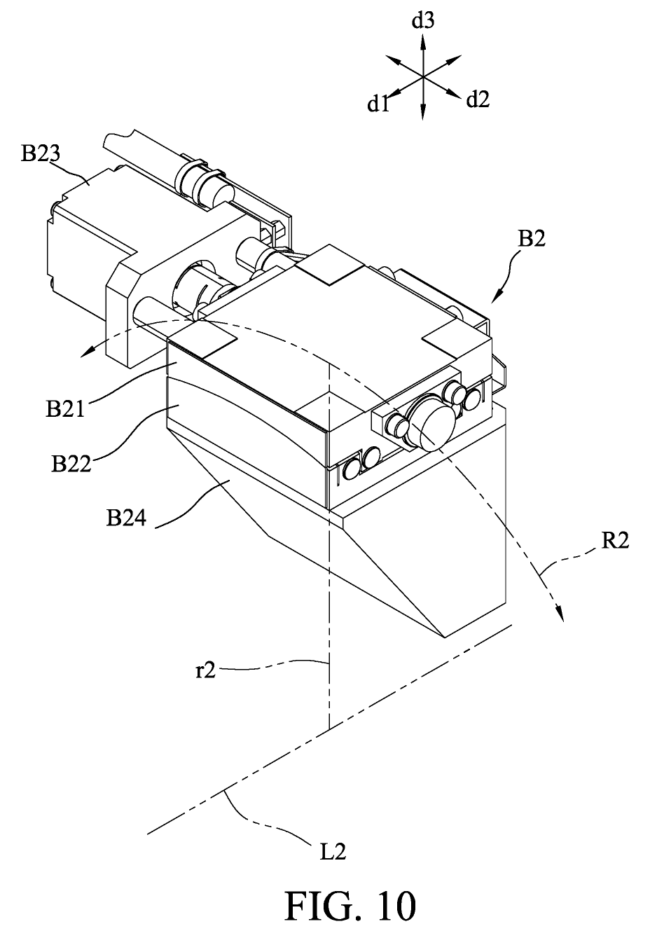

Referring to FIGS. 8 to 10, the second rotatable assembly (B2) is operable to drive the retention mechanism (C) (see FIG. 7) to rotate about a second axis (L2), and includes a second base seat (B21) mounted to the first connecting member (B14) (see FIG. 9), a second movable seat (B22) mounted to the second base seat (B21), a second driver (B23) for driving the second movable seat (B22) to move, and a second connecting member (B24) mounted to the second movable seat (B22). The second base seat (B21) is formed with an arcuate concave surface that faces the second movable seat (B22). The second movable seat (B22) is formed with an arcuate convex surface that faces the second base seat (B21) and that is complementary in shape with the arcuate concave surface of the second base seat (B21). The second movable seat (B22) is driven by the second driver (B23) to move arcuately along the second base seat (B21) so that the second connecting member (B24) is driven thereby to move along a second arcuate path (R2) up and down as depicted in FIG. 10. The second movable seat (B22) rotates about the second axis (L2) that is parallel to the first direction (d1). As shown in FIG. 10, a distance between each of a plurality of points on the second arcuate path (R2) and the second axis (L2) is defined as a second radius (r2). In this embodiment, the second base seat (B21) and the second movable seat (B22) are movable relative to each other through a cross bearing, but the present disclosure is not limited hereto.

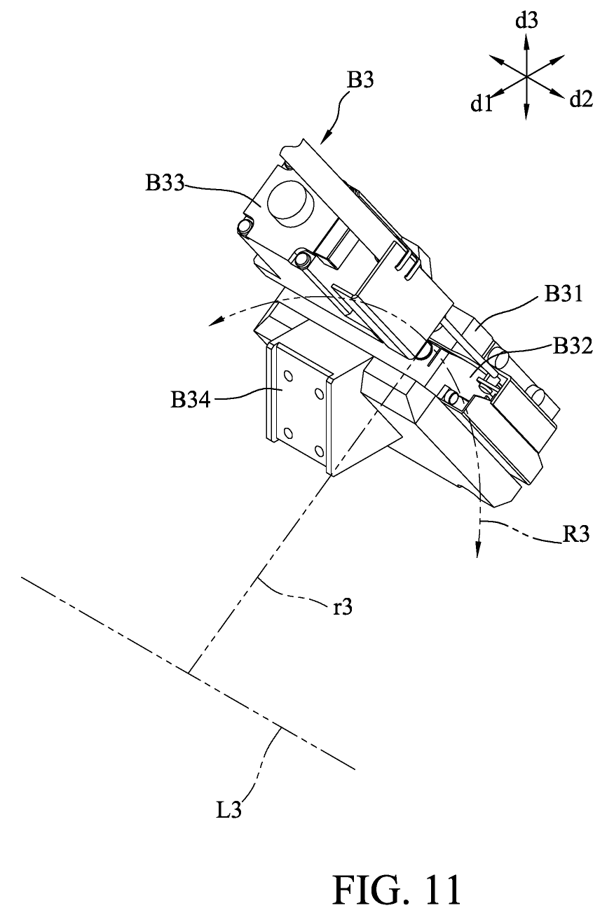

With reference to FIGS. 8, 10 and 11, the third rotatable assembly (B3) is operable to drive the retention mechanism (C) (see FIG. 7) to rotate about a third axis (L3), and includes a third base seat (B31) mounted to the second connecting member (B24) (see FIG. 10), a third movable seat (B32) mounted to the third base seat (B31), a third driver (B33) for driving the third movable seat (B32) to move, and a third connecting member (B34) mounted to the third movable seat (B32). The third base seat (B31) is formed with an arcuate concave surface that faces the third movable seat (B32). The third movable seat (B32) is formed with an arcuate convex surface that faces the third base seat (B31) and that is complementary in shape with the arcuate concave surface of the third base seat (B31). The third movable seat (B32) is driven by the third driver (B33) to move arcuately along the third base seat (B31) so that the third connecting member (B34) is driven thereby to move along a third arcuate path (R3) front and rear as depicted in FIG. 11. The third movable seat (B32) rotates about the third axis (L3) that is parallel to the second direction (d2). As shown in FIG. 11, a distance between each of a plurality of points on the third arcuate path (R3) and the third axis (L3) is defined as a third radius (r3). In this embodiment, the third base seat (B31) and the third movable seat (B32) are movable relative to each other through a cross bearing, but the present disclosure is not limited hereto.

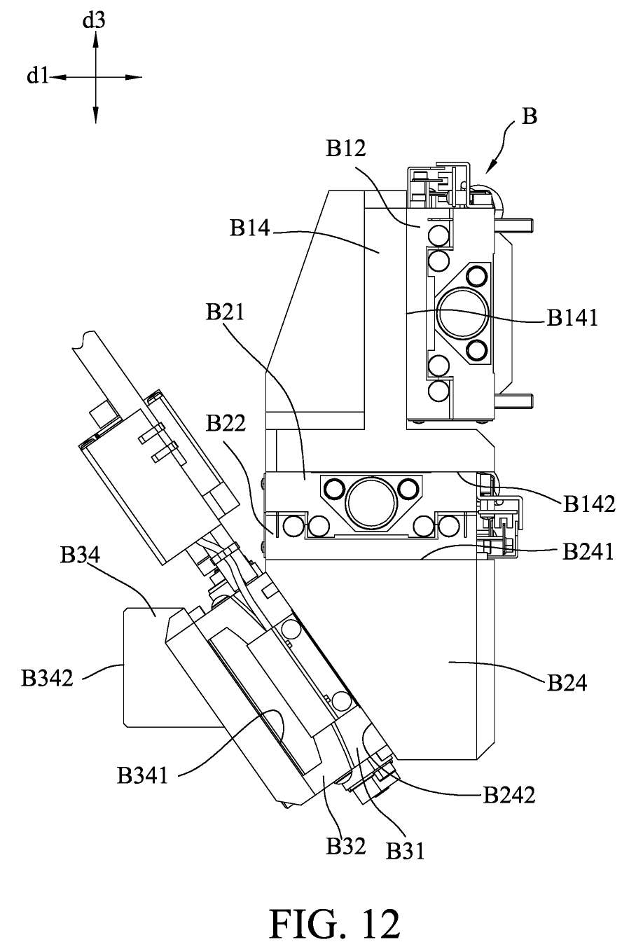

Referring to FIGS. 8 and 12, the first connecting member (B14) has a first connection surface (B141) extending vertically and a second connection surface (B142) extending horizontally. The second connecting member (B24) has a third connection surface (B241) extending horizontally and a fourth connection surface (B242) extending inclinedly. The third connecting member (B34) has a fifth connection surface (B341) extending inclinedly and a sixth connection surface (B342) extending vertically. The first connection surface (B141) is substantially parallel to the sixth connection surface (B342). The fourth connection surface (B242) is substantially parallel to the fifth connection surface (B341). The first connection surface (B141) of the first connecting member (B14) is mounted to the first movable seat (B12) of the first rotatable assembly (B1). The second rotatable assembly (B2) is disposed under the first connecting member (B14) in the third direction (d3). The second base seat (B21) is mounted to the second connection surface (B142) of the first connecting member (B14). The third connection surface (B241) of the second connecting member (B24) is mounted to the second movable seat (B22). The third base seat (B31) of the third rotatable assembly (B3) is mounted to the fourth connection surface (B242) of the second connecting member (B24) that is inclined. The fifth connection surface (B341) of the third connecting member (B34) that is inclined is mounted to the third movable seat (B32). The retention mechanism (C) (see FIG. 7) is mounted to the sixth connection surface (B342).

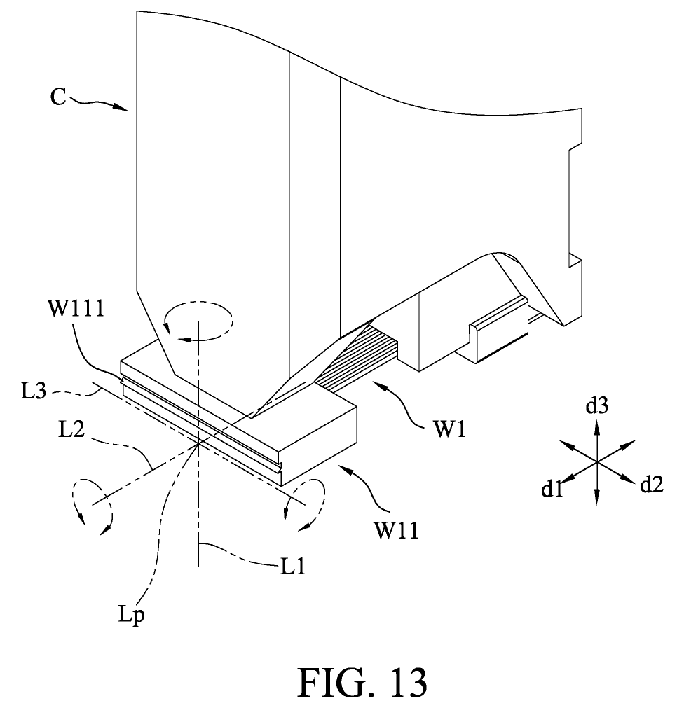

Referring to FIGS. 7 and 13, the first axis (L1), the second axis (L2), and the third axis (L3) are normal to each other and intersect at an axial point (Lp). The second drive mechanism (B) is operable to drive the retention mechanism (C) to drive rotations of the fiber array unit (W1) with the axial point (Lp) serving as a rotation center. Specifically, one or more of the first rotatable assembly (B1), the second rotatable assembly (B2), and the third rotatable assembly (B3) drives rotation of the retention mechanism (C) such that the retention mechanism (C) drives the fiber array unit (W1) to rotate about one or more of the first axis (L1), the second axis (L2), and the third axis (L3). When the retention mechanism (C) retains the fiber array unit (W1), the axial point (Lp) is located at a position under the optical coupler (W11) of the fiber array unit (W1) in the third direction (d3) and in front of the prism (W111) of the fiber array unit (W1) in the first direction (d1). As shown in FIG. 5, when the fiber array unit (W1) is coupled to the integrated circuit component (W2), a lower region of the optical coupler (W11) and a front region of the prism (W111) are substantially disposed above an upper surface of the photonic integrated circuit (W23) and correspond in position to the lens array (W231). In this embodiment, the first axis (L1), the second axis (L2), and the third axis (L3) are normal to each other. In other embodiments, the first axis (L1), the second axis (L2), and the third axis (L3) may merely intersect with each other.

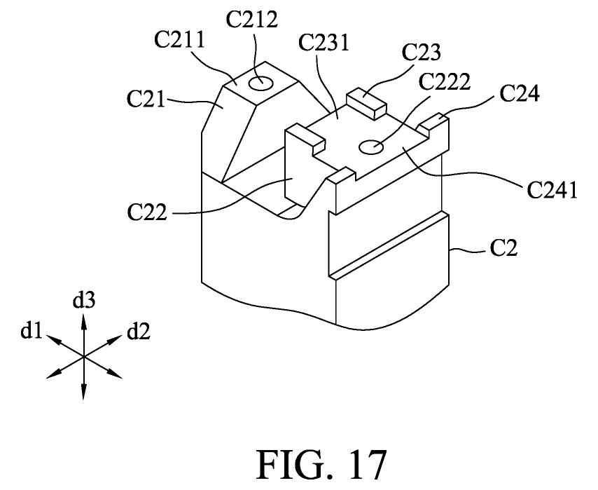

Referring to FIGS. 7, 14 and 15, the retention mechanism (C) includes a support frame (C1) that is mounted to the sixth connection surface (B342) of the third connecting member (B24), a retention member (C2) that is mounted to the support frame (C1) and that is adapted for retaining the fiber array unit (W1), a connector member (C3) that is movable relative to the retention member (C2), that is indirectly mounted to the support frame (C1), and that is adapted to be connected to the measurement unit 1, a drive unit (C4) that is mounted to the support frame (C1) and that is operable to drive the connector member (C3) to move in the first direction (d1), and a curing unit (C5) disposed on the support frame (C1) and for curing the first adhesive (F1) and the second adhesive (F2). As shown in FIG. 17, the support frame (C1) is formed with a valve (C11) in fluid communication with a negative pressure source (not shown), and an air passage (C12) in fluid communication with the valve (C11). The retention member (C2) and the connector member (C3) are mounted to the support frame (C1) and are co-movable. The connector member (C3) is driven by the drive unit (C4), is movable linearly relative to the retention member (C2) in the first direction (d1), and is adapted to be detachably connected to the fiber array unit (W1). Thus, the retention mechanism (C) not only retains the fiber array unit (W1) but is connected to the fiber array unit (W1) through the connector member (C3) for the measurement unit 1 to measure the intensity of the optical signal (W3) transmitted back to the fiber array unit (W1).

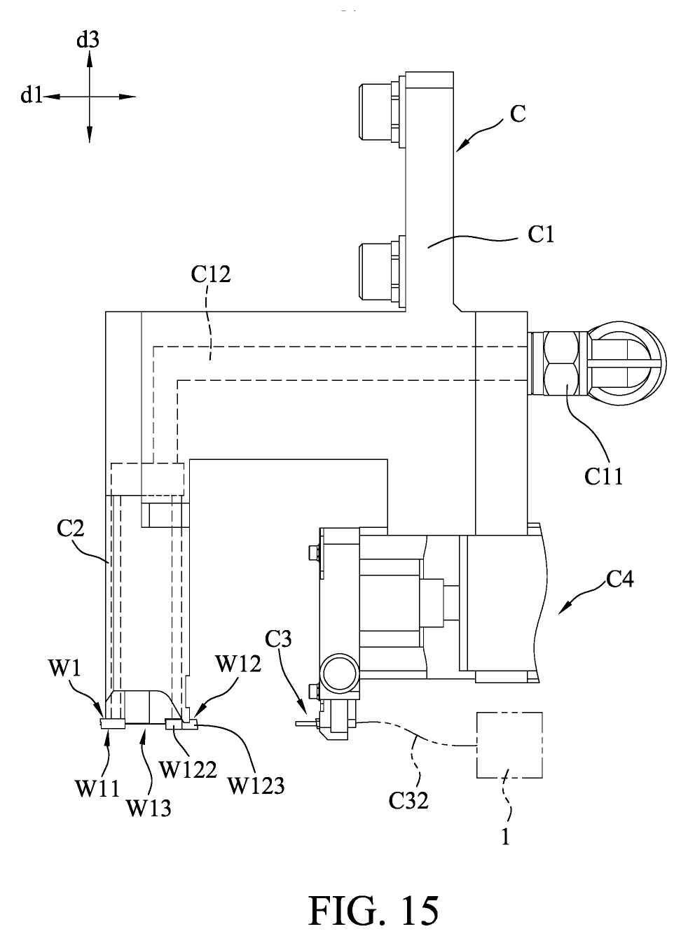

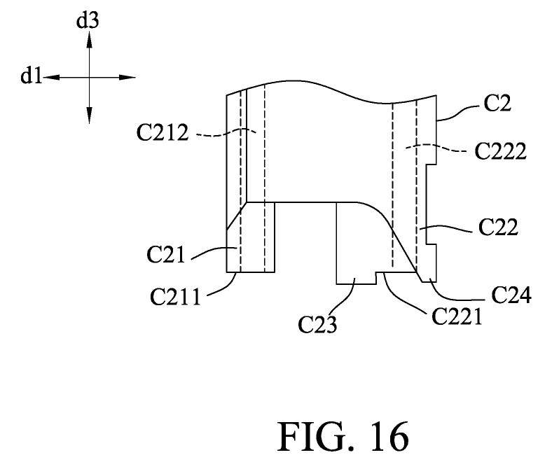

Referring to FIGS. 15 to 17, the retention member (C2) is adapted for retaining the fiber array unit (W1), and includes a first retention portion (C21) and a second retention portion (C22) spaced apart from the first retention portion (C21) in the first direction (d1). The first retention portion (C21) is for retaining the optical coupler (W11) of the fiber array unit (W1). The second retention portion (C22) is adapted for retaining the receptacle portion (W12) of the fiber array unit (W1). By virtue of the retention member (C2) that securely retains two opposite ends (i.e., the optical coupler (W11) and the receptacle portion (W12)) of the fiber array unit (W1) by the first retention portion (C21) and the second retention portion (C22), the fiber array unit (W1) is securely retained by the retention member (C2), thereby reducing a possibility that the fiber array unit (W1) falls off from the retention mechanism (C). The first retention portion (C21) has a first retention surface (C211) facing downwardly and a first negative pressure hole (C212) that is formed through the first retention surface (C211) and that is in fluid communication with air passage (C12). The second retention portion (C22) has a second retention surface (C221) facing downwardly and a second negative pressure hole (C222) that is formed through the second retention surface (C221) and that is in fluid communication with the air passage (C12). When the negative pressure source is turned on so a negative pressure is provided in the air passage (C12), the first retention surface (C211) is adapted to be in contact with the optical coupler (W11) for picking up and retaining the same through the first negative pressure hole (C212), and the second retention surface (C221) is adapted to be in contact with the receptacle portion (W12) for picking up and retaining the same through the second negative pressure hole (C222). The retention member (C2) further includes a first limit portion (C23) and a second limit portion (C24). The first limit portion (C23) is disposed on one side of the second retention portion (C22) that is adjacent to the first retention portion (C21), and includes a first accommodating region (C231) adapted for the optical fiber portion (W13) of the fiber array unit (W1) to extend therethrough. The second limit portion (C24) is disposed on another side of the second retention portion (C22) away from the first retention portion (C21), has a width in the second direction (d2) greater than a width of the first limit portion (C23) in the second direction (d2), and includes a second accommodating region (C241) adapted for the second seat portion (W123) of the receptacle portion (W12) to extend therethrough. When the fiber array unit (W1) is retained by the retention member (C2), the first limit portion (C23) and the second limit portion (C24) are adapted to limit movement in the first direction (d1) of the first seat portion (W122) that has the width in the second direction (d2) larger than the width of the second seat portion (W123) in the second direction (d2).

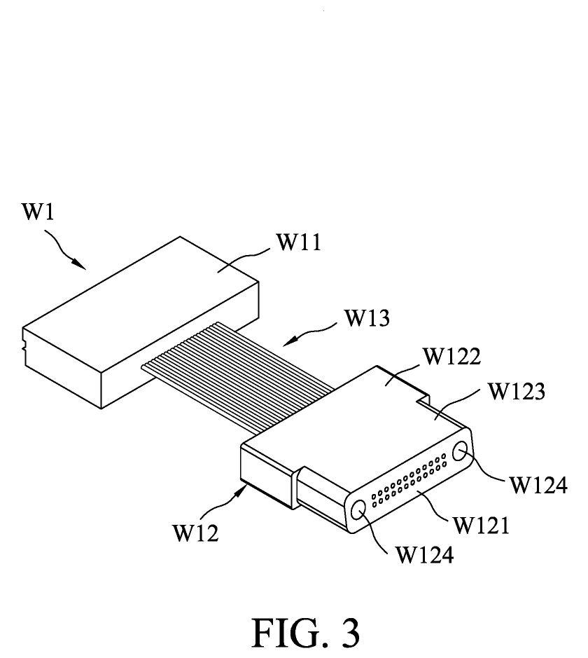

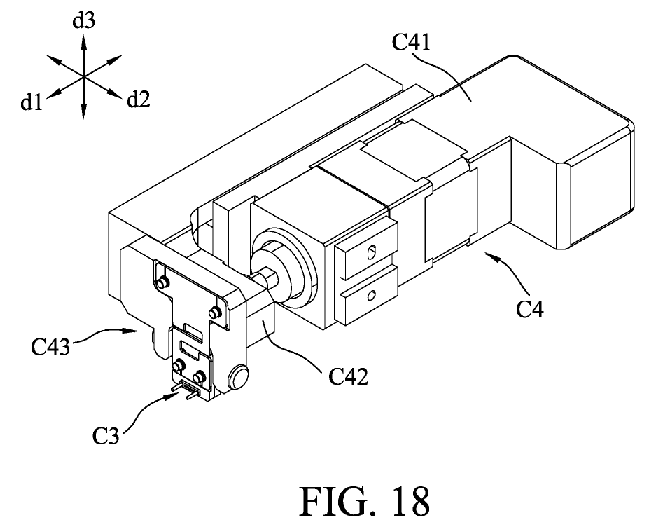

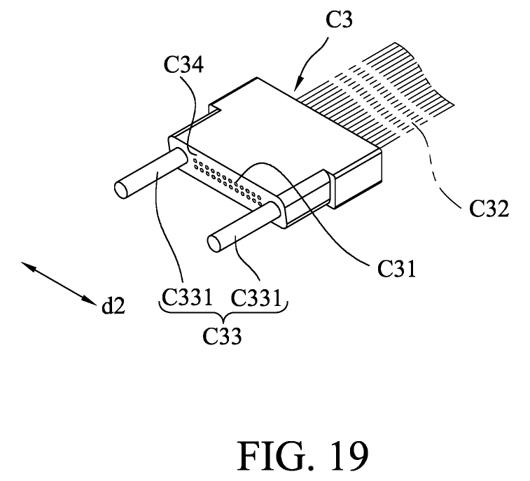

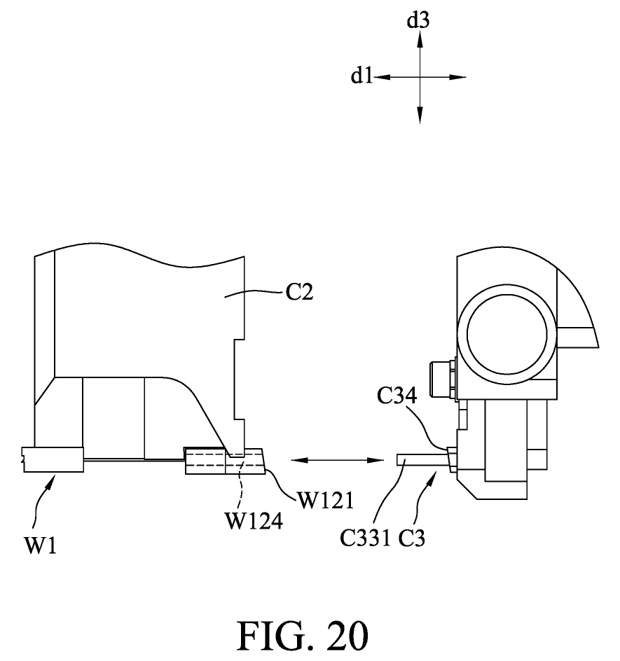

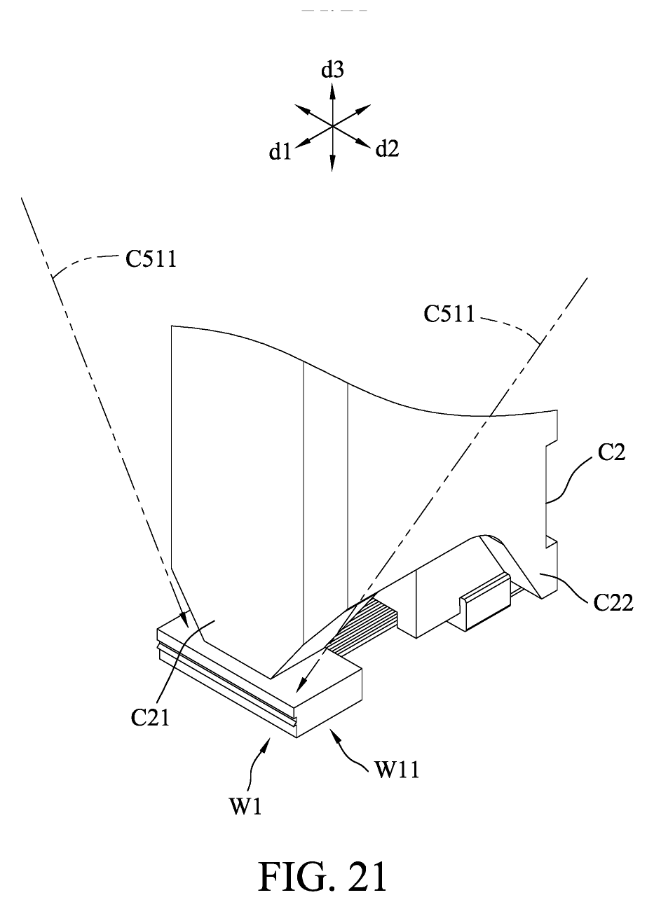

Referring to FIGS. 18 to 20, the connector member (C3) includes a light passage portion (C31), a light transmission portion (C32) connected between the light passage portion (C31) and the measurement unit 1, a guiding portion (C33) adapted to be inserted into the fiber array unit (W1), and an abutment surface (C34) facing the retention member (C2), tilted inwardly from the top to the bottom, and provided for the light passage portion (C31) and the light transmission portion (C32) to mount thereto. As shown in FIG. 19, the guiding portion (C33) includes two guide pins (C331) spaced apart from each other in the second direction (d2) and adapted to be respectively inserted into the two guide holes (W124) of the receptacle portion (W12) (see FIG. 3). Specifically, the abutment surface (C34) and the second side surface (W121) are parallel to and complementary with each other. As shown in FIG. 21, the guiding portion (C33). When the guide pins (C331) are respectively inserted into the guide holes (W124), the abutment surface (C34) abuts against the second side surface (W121) and the light passage portion (C31) corresponds in position to the optical fiber portion (W13) of the fiber array unit (W1), such that the optical signal (W3) (see FIG. 5) outputted from the measurement unit 1 may be transmitted to the fiber array unit (W1). The drive unit (C4) includes a driver member (C41) mounted to the support frame (C1) (see FIG. 15), a movable member (C42) driven by the driver member (C41) to move, and a mounting seat (C43) mounted to the movable member (C42). The connector member (C3) is mounted to the mounting seat (C43) that is driven by the driver member (C41) to move relative to the retention member (C2) in the first direction (d1), and is adapted to be detachably connected to the fiber array unit (W1).

Referring to FIGS. 14, 16, and 21, the curing unit (C5) includes two first light sources (C51) that are spaced apart from each other in the second direction (d2), that are mounted to the support frame (C), and that are mounted to two opposite sides of the retention member (C2). The first light sources (C51) are operable to emit two light beams (C511) that are ultraviolet light or laser light toward the first retention portion (C21) of the retention member (C2). It should be noted that in other embodiments of the present disclosure, in a case where the first adhesive (F1) is an ultraviolet cured adhesive and the second adhesive (F2) is a heat cured adhesive, the curing unit (C5) further includes two second light sources that are respectively spaced apart from the first light sources (C51) in the first direction (d1) and that are operable to emit laser light toward the second retention portion (C22) of the retention member (C2), and the first light sources (C51) are operable to emit ultraviolet light toward the first retention portion (C21) of the retention member (C2). The numbers of the first light sources (C51) and the second light sources may be modified and the present disclosure is not limited hereto.

Referring to FIGS. 6, 7 and 14, before the component coupling device 2 performs coupling of the fiber array unit (W1) to the integrated circuit component (W2), the fiber array unit (W1) is first placed on the first stage 3 and the integrated circuit component (W2) (see FIG. 5) is placed on the second stage 4. When the component coupling device 2 performs coupling operation, the first drive mechanism (A) drives the inspection mechanism (D) to move horizontally to be disposed above the second stage 4 to obtain, by means of image capturing, multi-point distance measurement, etc., the orientation of one of the photonic integrated circuits (W23) and/or the lens array (W231) of the one of the photonic integrated circuits (W23), and the inclination degree of the upper surface of the one of the photonic integrated circuits (W23). The control unit 7 is electrically connected to the inspection mechanism (D) and is configured to store the orientation of the one of the photonic integrated circuits (W23) and/or the lens array (W231) and the inclination degree of the upper surface of the one of the photonic integrated circuits (W23) upon receipt of the same. Subsequently, the first drive mechanism (A) drives the second drive mechanism (B) to drive movement of the retention mechanism (C) horizontally in the second direction (d2) to be disposed above the first stage 3. Then, when the second drive mechanism (B) is driven by the first drive mechanism (A) to drive the retention mechanism (C) to move downwardly in the third direction (d3), the retention member (C2) comes into contact with the fiber array unit (W1) carried on the first stage 3. At the same time, the negative pressure source connected to the valve (C11) is turned on and a negative pressure is provided in the air passage (C12), such that the first retention portion (C21) and the second retention portion (C22) of the retention member (C2) respectively suck the optical coupler (W11) and the receptacle portion (W12) of the fiber array unit (W1) to pick up the fiber array unit (W1). Subsequently, the drive unit (C4) drives the connector member (C3) to move toward the fiber array unit (W1) to be coupled to the fiber array unit (W1), so the optical signal (W3) outputted from the measurement unit 1 may be transmitted to the fiber array unit (W1). For example, the measurement unit 1 may be a passive optical component testing platform including a tunable laser module, a switch, a polarizer, and a test instrument for testing Wavelength Division Multiplexing (WDM) devices and photonic integrated circuits. It should be noted that, in this embodiment, each of the measurement unit 1 and the control unit 7 includes a microcontroller or a controller such as, but not limited to, a single core processor, a multi-core processor, a dual-core mobile processor, a microprocessor, a digital signal processor (DSP), a field-programmable gate array (FPGA), an application specific integrated circuit (ASIC), a radio-frequency integrated circuit (RFIC), etc. In addition, each of the measurement unit 1 and the control unit 7 may be embodied in: executable software as a set of logic instructions stored in a machine- or computer-readable storage medium of a memory such as random access memory (RAM), read only memory (ROM), programmable ROM (PROM), firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

The first drive mechanism (A) drives the second drive mechanism (B) to drive the retention mechanism (C) to move upwards, such that the retention member (C2) that retains the fiber array unit (W1) is moved away from the first stage 3. Then, the first drive mechanism (A) drives the second drive mechanism (B) to move horizontally in the second direction (d2) toward the detection device 6, so that the detection device 6 may obtain, by means of image capturing, multi-point distance measurement, etc., an orientation of the optical coupler (W11) and/or the prism (W111) of the fiber array unit (W1), obtain an inclination degree of the lower surface of the optical coupler (W11), and measure the intensity of the optical signal (W3). The control unit 7 is configured to store the orientation of the optical coupler (W11) and/or the prism (W111), the inclination degree of the lower surface of the optical coupler (W11), and the intensity of the optical signal (W3) upon receipt of the same.

Referring to FIGS. 6, 8 and 13, the control unit 7 is configured to compare the orientation of the optical coupler (W11) and/or the prism (W111) with the orientation of the one of the photonic integrated circuits (W23) and/or the lens array (W231) to obtain an orientation deviation, and to control, according to the orientation deviation, the first rotatable assembly (B1) of the second drive mechanism (B) to rotate about the first axis (L1) along the first arcuate path (R1) left and right as depicted in FIG. 9. In this way, a posture of the fiber array unit (W1) retained by the retention mechanism (C) is adjusted such that the orientation of the optical coupler (W11) and/or the prism (W111) is registered with the orientation of the one of the photonic integrated circuits (W23) and/or the lens array (W231). Furthermore, the control unit 7 is configured to compare the inclination degree of the lower surface of the optical coupler (W11) with the inclination degree of the one of the photonic integrated circuits (W23) to obtain an inclination deviation, and to control, according to the inclination deviation, the second rotatable assembly (B2) of the second drive mechanism (B) to rotate about the second axis (L2) along the second arcuate path (R2) up and down as depicted in FIG. 10 and the third rotatable assembly (B3) to rotate about the third axis (L3) along the third arcuate path (R3) front and rear as depicted in FIG. 11. In this way, the posture of the fiber array unit (W1) retained by the retention mechanism (C) is adjusted such that the lower surface of the optical coupler (W11) is parallel to the upper surface of the one of the photonic integrated circuits (W23).

Referring to FIGS. 2, 5 and 6, after the orientation and the inclination degree of the fiber array unit (W1) are adjusted, the first drive mechanism (A) drives the second mechanism (B) to drive movement of the retention mechanism (C) horizontally toward the adhesive coating device 5. The adhesive coating device 5 includes two adhesive valves respectively for coating the first adhesive (F1) onto the lower surface of the optical coupler (W11) and the second adhesive (F2) onto the lower surface the receptacle portion (W12).

After the first adhesive (F1) and the second adhesive (F2) are coated onto the fiber array unit (W1), the first drive mechanism (A) drives the second drive mechanism (B) to move the retention mechanism (C) horizontally to a position above the second stage 4. Since the posture of the fiber array unit (W1) is adjusted such that the orientation of the optical coupler (W11) and/or the prism (W111) is registered with the orientation of the one of the photonic integrated circuits (W23) and the lower surface of the optical coupler (W11) is parallel to the upper surface of the one of the photonic integrated circuits (W23), after the retention mechanism (C) is moved to the position above the second stage 4, the first drive mechanism (A) directly drives the second drive mechanism (B) to move together with the retention mechanism (C) downwardly in the third direction (d3), so the lower surface of the optical coupler (W11) and the lower surface of the receptacle portion (W12) that are respectively coated with the first adhesive (F1) and the second adhesive are respectively in contact with the upper surface of the one of the photonic integrated circuits (W23) and an upper surface of the second lid portion (W222) of the lid unit (W22). In this way, the optical signal (W3) may be transmitted between the fiber array unit (W1) and the integrated circuit component (W2) via the prism (W111) and the lens array (W231). At this time, the fiber array unit (W1) is still retained by the retention member (C2) of the retention mechanism (C).

After the fiber array unit (W1) is disposed on the integrated circuit component (W2), because the first adhesive (F1) and the second adhesive (F2) are not cured yet, and each of the first adhesive (F1) and the second adhesive (F2) has a certain height in the third direction (d3), the fiber array unit (W1) floats on the first adhesive (F1) and the second adhesive (F2) and may be adjusted in orientation and inclination degree by the retention mechanism (C) driven by the second drive mechanism (B).

At this time, as shown in FIG. 5, the measurement unit 1 measures the intensity of the optical signal (W3) transmitted back to the fiber array unit (W1). The control unit 7 is configured to determine whether the intensity of the optical signal (W3) falls within a predetermined range. When the intensity of the optical signal (W3) does not fall within the predetermined range, the second drive mechanism (B) is controlled to drive rotations of the fiber array unit (W1) with the axial point (Lp) serving as a rotational center, where the fiber array unit (W1) is rotatable about one or more of the first axis (L1), the second axis (L2), and the third axis (L3) with three degrees of freedom. That is to say, the posture of the fiber array unit (W1) may be slightly adjusted when being disposed on the integrated circuit component (W2) until the control unit 7 determines that the intensity of the optical signal (W3) falls within the predetermined range and thus the second drive mechanism (B) is controlled to stop moving. It should be noted that when the intensity of the optical signal (W3) that is transmitted back falls within the predetermined range, the optical signal (W3) transmission performance between the fiber array unit (W1) and the integrated circuit component (W2) is relatively good.

It should be noted that the order of operations of the second drive mechanism (B) is prioritized by the third rotatable assembly (B3), followed by the second rotatable assembly (B2) and then the first rotatable assembly (B1). When the intensity of the optical signal (W3) measured by the measurement unit 1 is determined by the control unit 7 to be within the predetermined range after the third rotatable assembly (B3) drives the retention mechanism (C) to rotate the fiber array unit (W1) about the third axis (L3), the first rotatable assembly (B1) and the second rotatable assembly (B2) are not required to be driven. When the intensity of the optical signal (W3) transmitted back is determined by the control unit 7 to not be within the predetermined range after the second drive mechanism (B) drives the retention mechanism (C) to slightly adjust the posture of the fiber array unit (W1), the first drive mechanism (A) is controlled to drive the second drive mechanism (B) together with the retention mechanism (C) to move the fiber array unit (W1) linearly in one or more of the first direction (d1), the second direction (d2), and the third direction (d3) with three degrees of freedom. Then, the second drive mechanism (B) is controlled to drive the retention mechanism (C) to drive rotations of the fiber array unit (W1) about one or more of the first axis (L1), the second axis (L2), and the third axis (L3) with three degrees of freedom to adjust the posture of the fiber array unit (W1). That is to say, the fiber array unit (W1) may be adjusted to a relatively large extent when being disposed on the integrated circuit component (W2) until the intensity of the optical signal (W3) is determined by the control unit 7 to fall within the predetermined range. Then, the first drive mechanism (A) and the second drive mechanism (B) are controlled to stop movement and rotation.

Referring to FIGS. 2, 14 and 21, when the intensity of the optical signal (W3) falls within the predetermined range, the curing unit (C5) cures the first adhesive (F1) and the second adhesive (F2) by ultraviolet light or the laser light. It should be noted that since the optical coupler (W11) is made of a light-transmissive material, the light beams (C511) may propagate through the optical coupler (W11) and cure the first adhesive (F1) disposed between the optical coupler (W11) and the photonic integrated circuit (W23). In addition, in the case where the first adhesive (F1) is an ultraviolet cured adhesive and the second adhesive (F2) is a heat cured adhesive, the second light sources of the curing unit (C5) emit laser light that is capable of generating heat to heat and cure the second adhesive (F2). After the first adhesive (F1) and the second adhesive (F2) are cured, the drive unit (C4) is driven to move away from the fiber array unit (W1) such that the connector member (C3) is detached from the fiber array unit (W1). Finally, the negative pressure source is turned off and the retention member (C2) is moved away from the fiber array unit (W1) to complete the process of coupling the fiber array unit (W1) to the one of the photonic integrated circuits (W23) of the integrated circuit component (W2).

Similarly, a predetermined number of the fiber array units (W1) may be sequentially coupled to the remaining photonic integrated circuits (W23) of the integrated circuit component (W2).

In the embodiment of the component coupling device 2 according to the present disclosure, the retention mechanism (C) retains the fiber array unit (W1), and is driven by the first drive mechanism (A) and the second drive mechanism (B) to move the fiber array unit (W1) linearly in a plurality of directions and to rotate about a plurality of axes. In this way, as compared to the prior art, independently driving movement of the integrated circuit component (W2) to cooperate with movement of the fiber array unit (W1) is not required. Thus, the fiber array unit (W1) may be securely coupled to the integrated circuit component (W2) without driving movement of the integrated circuit component (W2) to cooperate with movement of the fiber array unit (W1) and a yield rate of the component coupling device 2 is relatively good.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to lid various arrangements included within the spirit and scope of the broadest interpretation so as to encompass all such modifications and equivalent arrangements.

What is claimed is:

1. A component coupling device adapted to couple a fiber array unit to an integrated circuit component, and comprising:
a first drive mechanism;
a second drive mechanism that is disposed on said first drive mechanism and that is driven by said first drive mechanism to move linearly in a plurality of directions; and
a retention mechanism that is disposed on said second drive mechanism and that is driven by said second drive mechanism to rotate about a plurality of axes.

2. The component coupling device as claimed in claim 1, wherein:
said first drive mechanism includes
a first straight movement unit adapted to be disposed on a machine bed and operable to drive said second drive mechanism to move linearly in a first direction,
a second straight movement unit mounted to said first straight movement unit and operable to drive said second drive mechanism to move linearly in a second direction,
a third straight movement unit mounted to said second straight movement unit and operable to drive said second drive mechanism to move linearly in a third direction;
one of said first straight movement unit, said second straight movement unit, said third straight movement unit, and a combination thereof drives said second drive mechanism to move linearly such that said retention mechanism drives movement of the fiber array unit; and
the first direction, the second direction and the third direction are normal to each other.

3. The component coupling device as claimed in claim 2, wherein the first direction and the second direction are horizontal directions and the third direction is a vertical direction.

4. The component coupling device as claimed in claim 1, wherein:
said second drive mechanism includes
a first rotatable assembly mounted to said first drive mechanism and operable to drive said retention mechanism to rotate about a first axis,
a second rotatable assembly mounted to said first rotatable assembly and operable to drive said retention mechanism to rotate about a second axis, and
a third rotatable assembly mounted to said second rotatable assembly and operable to drive said retention mechanism to rotate about a third axis;
one of said first rotatable assembly, said second rotatable assembly, said third rotatable assembly, and a combination thereof drives rotation of said retention mechanism such that said retention mechanism drives rotation of the fiber array unit;
the first axis is parallel to a third direction, the second axis is parallel to a first direction, and the third axis is parallel to a second direction; and
the first direction, the second direction, and the third direction are normal to each other.

5. The component coupling device as claimed in claim 4, wherein the first direction and the second direction are horizontal directions and the third direction is a vertical direction.

6. The component coupling device as claimed in claim 4, wherein:
the first axis, the second axis, and the third axis intersect at an axial point; and
said second drive mechanism is operable to drive said retention mechanism to drive rotation of the fiber array unit with the axial point serving as a rotational center.

7. The component coupling device as claimed in claim 6, wherein:
when said retention mechanism retains the fiber array unit, the axial point is located at a position under an optical coupler of the fiber array unit in the third direction, and in front of a prism of the fiber array unit in the first direction.

8. The component coupling device as claimed in claim 1, wherein:
said component coupling device further includes an inspection mechanism that is adapted for inspection of the integrated circuit component, and that is driven by said first drive mechanism to move linearly in the plurality of directions.

9. The component coupling device as claimed in claim 1, wherein:
said component coupling device is adapted to be used with a measurement unit;
said retention mechanism includes a retention member adapted for retaining the fiber array unit and a connector member adapted to be connected to the measurement unit; and
said connector member is movable relative to said retention member and adapted to be detachably connected to the fiber array unit.

10. The component coupling device as claimed in claim 1, wherein:
said retention mechanism includes a retention member adapted for retaining the fiber array unit;
said retention member includes a first retention portion and a second retention portion that are spaced apart from each other;
said first retention portion is adapted for retaining an optical coupler of the fiber array unit; and
said second retention portion is adapted for retaining a receptacle portion of the fiber array unit.
